(19) United States
(12) Patent Application Publication
(10) Pub. No.: US 2007/0215180 A1
(43) Pub. Date: Sep. 20, 2007

(54) CLEANING METHOD OF SUBSTRATE PROCESSING EQUIPMENT, SUBSTRATE PROCESSING EQUIPMENT, AND RECORDING MEDIUM FOR RECORDING PROGRAM THEREOF

(75) Inventor: Kiyohito IIJIMA, Nirasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 11/686,738

(22) Filed: Mar. 15, 2007

Related U.S. Application Data
(60) Provisional application No. 60/785,343, filed on Mar. 24, 2006.

(30) Foreign Application Priority Data
Mar. 15, 2006 (JP) 2006-071513

(51) Int. Cl. B08B 7/04

(52) U.S. Cl. 134/18

(57) ABSTRACT

A cleaning method of substrate processing equipment includes performing a processing chamber cleaning after a specific process is performed on a substrate transferred into the processing chamber. Further, in the cleaning method, the cleaning is performed by a kind of the process, based on specific cleaning setting information which is set in advance according to kinds of processes performed in the processing chamber. In addition, a further cleaning method of substrate processing equipment is provided, which includes performing a processing chamber cleaning after a specific process is performed on a substrate transferred into the processing chamber. Here, the cleaning is performed by a recipe for a kind of the process, based on cleaning recipes which are prepared by kinds of processes performed in the processing chamber and are pre-stored in a setting information memory unit.

### FIELD OF THE INVENTION

The present invention relates to a cleaning method of substrate processing equipment, substrate processing equipment, and a recording medium for recording a program thereof.

### BACKGROUND OF THE INVENTION

Substrate processing equipment such as a plasma processing device used for fabricating a semiconductor device, typically includes a processing chamber. A substrate such as a semiconductor wafer, a liquid crystal substrate, and the like, is transferred into the processing chamber, where an etching process, a layer formation process, and the like are performed on the substrate.

In the substrate processing equipment, it is important to properly remove particles (foreign substances having fine particle shapes) including reaction products during a substrate processing process in the processing chamber, or particles entering the processing chamber from outside.

For example, when particles remain in a mounting table, positioned in the processing chamber, when loading a substrate, the particles get stuck to a backside of the substrate being mounted on the mounting table, thereby causing problems in the subsequent processes. Further, when particles remain in the processing chamber, the particles get stuck to the top of the substrate, thereby deteriorating a processing process of the substrate. Therefore, the quality of a semiconductor device which is finally fabricated on the substrate cannot be ensured.

As a method of effectively removing particles remaining in the processing chamber, for example, Patent Reference 1 discloses a cleaning method of removing reaction products from the mounting table, by generating radicals in the processing chamber and by making a chemical reaction between the radicals and the products accumulated on the mounting table. In addition, Patent Reference 2 discloses a cleaning method of removing particles remaining in the processing chamber by changing the distance between electrodes in two steps and by generating plasma. The processing chamber is cleaned after a specific process is performed on a substrate transferred into the processing chamber.

[Patent Reference 1]

Japanese Patent Laid-open Publication No. 2006-19626

[Patent Reference 2]

Japanese Patent Laid-open Publication No. Hei 8-176828

However, there are cases where a plurality of specific processes is to be performed in the processing chamber. Examples of such processes may include a processing process and a processing chamber condition controlling process performed prior to the processing process. For example, the processing process includes an etching process performed on the substrate. The processing chamber condition controlling process is performed to control an internal condition of the processing chamber (chamber condition), which includes, for example, an amount of reaction products remaining on the inner wall of the processing chamber, or to control an internal temperature of the processing chamber.

However, when the processing chamber cleaning is performed on a same set of conditions (for example, recipe, timing, and the like) without accounting for the kinds (classes) of specific processes, the cleaning is likely to be excessive or deficient. For example, when the cleaning is deficient, depending on a kind of a process, particles may be generated. When the cleaning is excessive, depending on the kind of a process, the conditions inside the processing chamber (for example, the amount of reaction products which remain on the inner wall of the processing chamber or the internal temperature of the processing chamber) may not be optimally set. The deficient or excessive cleaning may unreasonably affect the processing process, and furthermore, it may deteriorate the quality of a semiconductor device fabricated on the substrate.

Further, depending on the kinds of processes being performed in the processing chamber, the cleaning may not be performed after every process. However, in case the cleaning for those processes is performed every time the processes are ended, a required time for completing the process of the specific number of substrates becomes longer, thereby decreasing throughput.

### SUMMARY OF THE INVENTION

It is, therefore, an object of the present invention to provide an optimum cleaning method of the substrate processing equipment by performing different cleanings depending on the kinds of processes.

In accordance with a first aspect of the present invention, a cleaning method of substrate processing equipment includes performing a processing chamber cleaning after a specific process is performed on a substrate transferred into the processing chamber, wherein the cleaning is performed by a kind of the process, based on specific cleaning setting information which is set in advance according to kinds of processes performed in the processing chamber.

In accordance with a second aspect of the present invention, a substrate processing equipment which performs a processing chamber cleaning after a specific process is performed on a substrate transferred into the processing chamber includes a setting information memory unit which stores cleaning setting information by kinds of processes performed in the processing chamber; and a control unit which, upon cleaning, performs the cleaning for the kind of the process, based on the cleaning setting information being obtained from the setting information memory unit.

Further, since cleaning setting information (for example, cleaning recipes and cleaning timing) is provided according to kinds of processes performed in a processing chamber, cleaning for the kinds of the processes may be performed by setting optimum values thereof. Accordingly, the internal condition of the processing chamber (chamber condition) may be optimized and throughput may be improved.

In accordance with a third aspect of the present invention, a cleaning method of substrate processing equipment includes performing a processing chamber cleaning after a specific process is performed on a substrate transferred into the processing chamber, wherein the cleaning is performed by a recipe for a kind of the process, based on cleaning recipes which are prepared by kinds of processes performed in the processing chamber and are pre-stored in a setting information memory unit.

Further, since cleaning recipes are provided according to the kinds of processes performed in the processing chamber, optimum cleaning for the kinds of the processes may be performed by adjusting each cleaning recipe.

Further, the kinds of the processes performed in the processing chamber may include, for example, a processing process performed on a target substrate by transferring the substrate into the processing chamber, and a processing chamber condition controlling process which is performed to control an internal condition of the processing chamber so as to maintain the internal condition suitable for the processing process, by transferring a control substrate into the processing chamber, before the processing process may be performed. In this case, at least cleaning recipes may be individually stored by the kinds of processes in the setting information memory unit.

The cleaning recipe may include, for example, a time for performing the cleaning and an internal temperature of the processing chamber. When the cleaning is performed after the processing chamber condition controlling process, the time for performing the cleaning and/or the internal temperature of the processing chamber may be set, depending on a required condition of the processing chamber for the processing process. Therefore, optimum cleaning may be performed according to the condition of the processing chamber.

The time duration for performing the cleaning may be set by the kinds of the processes. For example, the time for performing the cleaning for processing chamber condition controlling process is set to be longer than that for the processing process. Accordingly, the cleaning for the processing chamber condition controlling process may be prevented from being deficient, thereby allowing the condition of the processing chamber to be optimized.

Further, the internal temperature of the processing chamber may be set by the kinds of the processes. For example, the internal temperature of the processing chamber for the processing chamber condition controlling process is set to be higher than that for the processing process. Accordingly, even if the cleaning time is not long, the cleaning for the processing chamber condition controlling process may be controlled so as not to be deficient.

In accordance with a fourth aspect of the present invention, a cleaning method of substrate processing equipment includes performing a processing chamber cleaning after a specific process is performed on a substrate transferred into the processing chamber, wherein the cleaning is performed by timing for a kind of the process, based on cleaning timing which is provided by kinds of processes performed in the processing chamber and is pre-stored in a setting information memory unit.

Further, the cleaning timing may be provided according to the kinds of the processes performed in the processing chamber. Cleaning may be performed at optimum timing depending on the kinds of the processes. Accordingly, the number of cleaning may be reduced, thereby improving the throughput.

Further, the kinds of the processes performed in the processing chamber may include at least a processing process which is performed on a target substrate, by transferring the substrate into the processing chamber, and a processing chamber condition controlling process which is performed to control an internal condition of the processing chamber so as to maintain the internal condition suitable for the processing process, by transferring a control substrate into the processing chamber, before the processing process may be performed. In this case, at least cleaning timing may individually be stored by the kinds of processes in the setting information memory unit.

The cleaning timing may be set, for example, by the number of the substrates to be processed. Upon the processing chamber condition controlling process, the cleaning may be performed only when the processing chamber condition controlling process of the set number of the control substrates is ended. Upon the processing process, the cleaning may be performed only when the processing process of the set number of the substrates to be processed is ended. Accordingly, the cleaning may be performed at optimum timing according to the kinds of the processes, thereby reducing the cleaning time and improving the throughput.

Both of the cleaning recipes and the cleaning timing may be set by the kinds of the processes, thereby allowing the cleaning to be performed under more appropriate recipes and timing. Accordingly, the internal condition of the processing chamber may be optimized and the throughput is improved.

In accordance with a fifth aspect of the present invention, a cleaning method of substrate processing equipment, which performs a processing chamber cleaning after a specific process is performed on a substrate transferred into the processing chamber includes: including a setting information memory unit which stores cleaning setting information by kinds of processes performed in the processing chamber; determining a kind of the process performed in the processing chamber; obtaining the cleaning setting information for the kind of the process being determined, from the setting information memory unit; and performing the cleaning for the kind of the process, based on the cleaning setting information being obtained.

In accordance with a sixth aspect of the present invention, a substrate processing equipment which performs a processing chamber cleaning after a specific process is performed on a substrate transferred into the processing chamber includes: a setting information memory unit which stores cleaning setting information, which is set depending on kinds of processes performed in the processing chamber; and a control unit which, upon cleaning, determines the kind of the process performed in the processing chamber, obtains the cleaning setting information for the kind of the process being determined from the setting information memory unit, and performs the cleaning for the kind of the process, based on the cleaning setting information being obtained.

In accordance with the present invention, there is provided a computer readable recording medium for recording a program to perform a cleaning method of substrate processing equipment which performs a processing chamber cleaning after a specific process is performed on a substrate transferred into the processing chamber. Here, the substrate processing equipment includes a setting information memory unit for storing cleaning setting information by kinds of processes performed in the processing chamber, and a computer stores a program for performing steps of determining a kind of the process performed in the processing chamber; obtaining the cleaning setting information for the kind of the process being determined from the setting information memory unit; and performing the cleaning for the kind of the process, based on the cleaning setting information being obtained.

Further, the optimum cleaning is performed by the kinds of the processes which are performed in the processing chamber. Accordingly, the internal condition of the processing chamber (chamber condition) may be optimized and the throughput may be improved.

Further, the cleaning is performed by generating plasma in the processing chamber. However, the cleaning may be performed without generating plasma in the processing chamber. Further, the cleaning may be performed with or without a substrate in the processing chamber.

### BRIEF DESCRIPTION OF THE DRAWINGS

The above and other objects and features of the present invention will become apparent from the following description of preferred embodiments given with reference to the accompanying drawings, in which:

FIG. 1 is a sectional view of the constitution of a plasma processing device in accordance with a first embodiment of the present invention;

FIG. 2 is a block diagram illustrating a constitutional example of a control unit shown in FIG. 1;

FIG. 3 is a block diagram illustrating a specific example of a process performed in a processing chamber, relating to the first embodiment of the present invention;

FIG. 4 is a view illustrating a specific example of cleaning setting information shown in FIG. 2;

FIG. 5 is a block diagram illustrating the process of the plasma processing device in accordance with the first embodiment of the present invention;

FIG. 6 is a flow chart illustrating a specific example of cleaning, relating to the first embodiment of the present invention;

FIG. 7 is a flow chart illustrating a specific example of cleaning performance contents shown in FIG. 6;

FIG. 8 is a view illustrating a specific example of the cleaning setting information shown in FIG. 2;

FIG. 9 is a block diagram illustrating the processes of a plasma processing device in accordance with a second embodiment of the present invention;

FIG. 10 is a flow chart illustrating a specific example of cleaning, relating to the second embodiment of the present invention; and

FIG. 11 is a flow chart illustrating another specific example of the cleaning, relating to the second embodiment of the present invention.

### DETAILED DESCRIPTION OF THE EMBODIMENTS

The present invention will be described more fully hereinafter with reference to the accompanying drawings, in which embodiments of the invention are shown. In describing the embodiments and drawings of the present invention, the elements, which have the substantially same functional constitution, are indicated by same reference numerals and are not described herein to avoid redundancy.

### First Embodiment

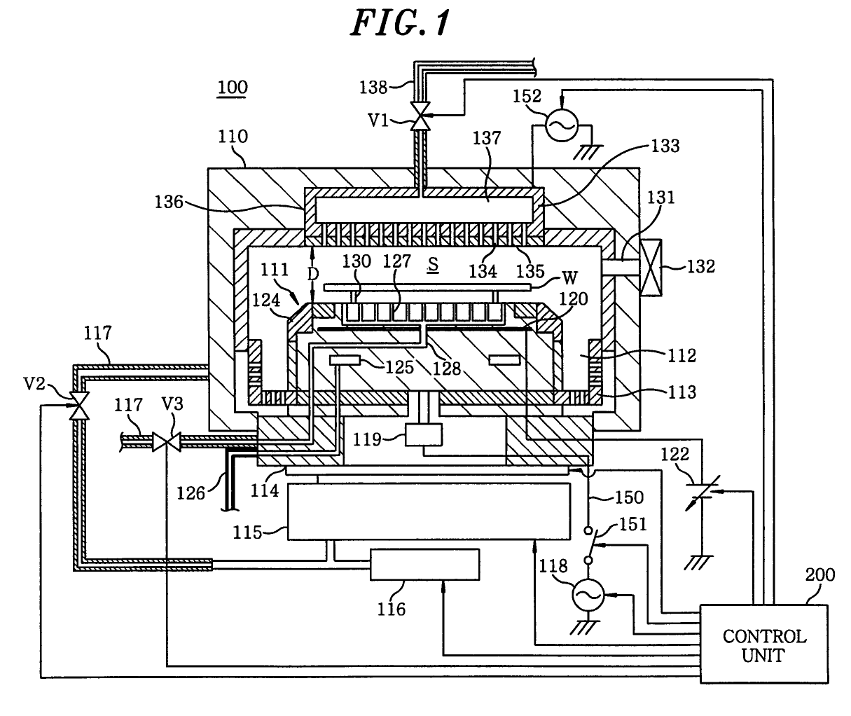

As substrate processing equipment according to a first embodiment of the present invention, a plasma processing device 100 will be described with reference to an accompanying drawing. FIG. 1 schematically illustrates the constitution of the plasma processing device 100. The plasma processing device 100 includes an etching processing device to perform an etching process on a semiconductor wafer (hereinafter, referred to as ‘wafer’) W, as a target substrate. The plasma processing device 100 includes a cylindrical processing chamber (chamber) 110 made of a metal material (for example, aluminum or stainless material). Further, a cylindrical susceptor 111, as a stage on which, for example, a 300 mm diameter wafer W is mounted, is included in the processing chamber 110.

An exhaust path 112 is formed between a sidewall of the processing chamber 110 and the susceptor 111. Gas above the susceptor 111 is discharged outwardly via the exhaust path 112. An annular baffle plate 113 is positioned in the exhaust path 112. A space under the baffle plate 113 of the exhaust path 112 is connected to an automatic pressure control valve which is a variable type butterfly valve (hereinafter, referred to as ‘adaptive pressure control (APC) valve’) 114. The APC valve 114 is connected to a turbo-molecular pump (hereinafter, referred to as ‘TMP’) 115 which is an exhaust vacuum pump and is connected to a dry pump (hereinafter, referred to as ‘DP’) 116 through the TMP 115. An exhaust flow path (hereinafter, referred to as ‘substantive exhaust line’), which is defined by the APC valve 114, the TMP 115 and the DP 116, is to decompress the processing chamber 110 so as to obtain a high vacuum state thereinside. The pressure in the processing chamber 110 is controlled by the APC valve 114.

Further, the space under the baffle plate 113 of the exhaust path 112 is connected to another exhaust line (hereinafter, referred to as ‘roughing exhaust line’) which is independent from the substantive exhaust line. The roughing exhaust line is defined by an exhaust pipe 117 including a valve V2 and the DP 116. Gas inside the processing chamber 110 is discharged typically via the roughing exhaust line, prior to being discharged via the substantive exhausting line.

An RF power source 118 is connected to the susceptor 111 serving as a lower electrode, through a conducting wire 150. A specific RF power is applied from the RF power source 118. The conducting wire 150 includes an adapter 119 and a switch 151. The adapter 119 maximizes the incidence efficiency of the RF power on the susceptor 111 by reducing reflection of RF power from the susceptor 111. The switch 151 makes or breaks conductivity of the conducting wire 150. The switch 151 is electrically connected between the susceptor 111 and the RF power source 118, and sets an electrical state of the susceptor 111 as a floating state or a conductive state. For example, when the wafer W is not mounted on the susceptor 111, the switch 151 makes the susceptor 111 to be in the electrically floating state.

A disc-shaped electrode plate 120 is positioned upwardly inside the susceptor 111. The electrode plate 120 includes a conductive layer to electrostatically adsorb the wafer W. A direct current power source 122 is electrically connected to the electrode plate 120. The wafer is adsorbed to be held on the susceptor 111, by the Coulomb force or Johnsen-Rahbek force generated by a direct current (DC) voltage which is applied from the direct current power source 122 to the electrode plate 120. A round annular-shaped focus ring 124 is made of silicon and the like, and disperses the plasma, which is generated above the susceptor 111, towards the wafer W.

The susceptor 111 includes a coolant chamber 125. In the coolant chamber 125, a coolant (for example, cooling water) of a specific temperature is circularly supplied from a chiller unit (not shown) via a conduit 126. A processing temperature of the wafer W mounted on the susceptor 111 is controlled by the coolant chamber 125.

A part of the susceptor 111 on which the wafer is adsorbed (hereinafter, referred to an ‘adsorption surface’) includes a plurality of heat transfer gas supply openings 127 and a plurality of heat transfer gas supply grooves (not shown). The heat transfer gas supply openings 127 and the heat transfer gas supply grooves are connected to a heat transfer gas supply unit (not shown), through a heat transfer gas supply line 128 included in the susceptor 111, and a heat transfer gas supply pipe 129 with a valve V3. Heating gas (for example, He gas) from the heat transfer gas supply openings 127 and the heat transfer gas supply grooves is supplied to a gap between the adsorption surface and the backside of the wafer W, thereby improving thermal conductivity of the wafer W and the susceptor 111. Further, the valve V3 controls an amount of the heat transfer gas being supplied from the heat transfer gas supply openings 127 and the heat transfer gas supply grooves.

Further, the adsorption surface includes a plurality of pusher pins 130 as lift pins which are configured to be freely protruded from the top plane of the susceptor 111. When a rotating motion of a motor (not shown) is converted to a straight line motion by means of a ball screw, the pusher pins 130 are moved vertically as shown. When the wafer W is adsorbed to be held on the adsorption surface, the pusher pins 130 are received in the susceptor 111. However, when the wafer W, on which a specific processing (for example, etching processing) process is ended, is transferred out of the processing chamber 110, the pusher pins 130 are protruded from the top of the susceptor 111, to lift the wafer W above the susceptor 111.

An upper electrode 133 is disposed at a ceiling portion of the processing chamber 110. A RF power source 152 is connected to the upper electrode 133 so that specific RF power is applied thereto.

The upper electrode 133 has the function of a shower head which is to introduce gas into the processing chamber. The upper electrode 133 includes an electrode plate 135 and an electrode supporter 136. The electrode plate 135 includes a number of gas vent holes 134. The electrode supporter 136 attachably or detachably supports the electrode plate 135. A buffer chamber 137 is positioned inside the electrode supporter 136. The buffer chamber 137 is connected to a processing gas inlet pipe 138 which is extended from a processing gas supply unit (not shown). The processing gas inlet pipe 138 includes a valve V1. The valve V1 controls an amount of the gas being supplied to the buffer chamber 137. The distance D between the susceptor 111 including the lower electrode and the upper electrode 133 (that is, the distance between the lower and upper electrode) is set as, for example, 35±1 mm or more.

A gate valve 132 is attached to the sidewall of the processing chamber 110. The gate valve 132 opens or closes an opening for transferring the wafer W in or out of the processing chamber 110. When the processing gas is supplied into the processing chamber 110 of the plasma processing device 100 and the RF power is applied to the upper electrode 133, high-density plasma is generated in a space S, thereby generating ions or radicals.

Further, the plasma processing device 100 includes a control unit 200 for controlling an operation of the entire device. The control unit 200 controls each part of the plasma processing device 100, based on specific setting information, by executing a specific program. The control unit 200 controls to perform, for example, specific processes in the processing chamber, such as a processing chamber condition controlling process, a processing process, and the like, or a processing chamber cleaning.

(Constructional Example of Control Unit)

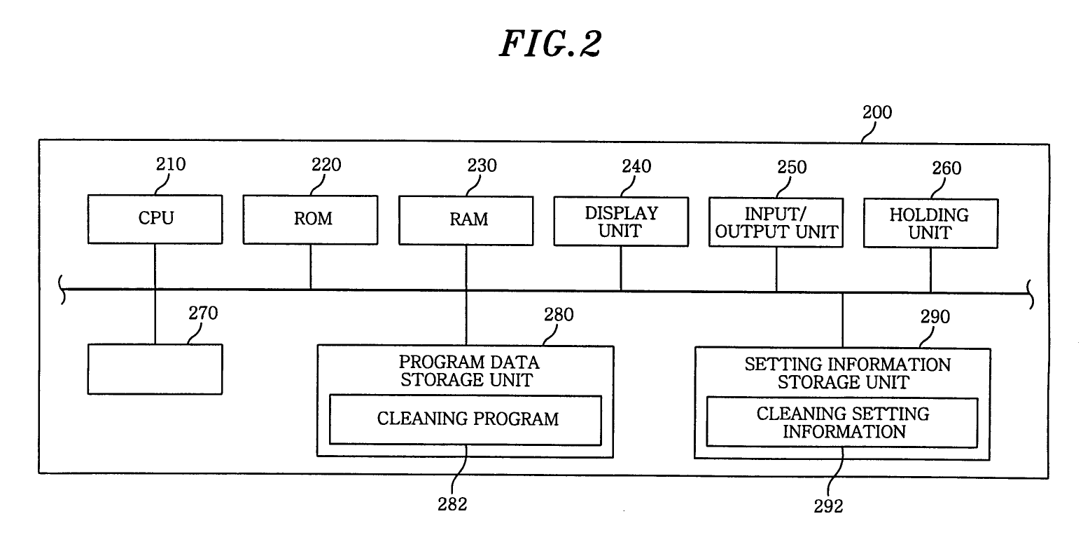

An example of the specific constitution of the control unit 200 will be described with reference to the drawing. As described in FIG. 2, the control unit 200 includes: a central processing unit (CPU) 210 forming a body of the control unit; a read only memory (ROM) 220 storing data which are used to control each part by the CPU 210; a random access memory (RAM) 230 providing memory array, and the like which are used for various data processing processes performed by the CPU 210; a display unit 240 including a liquid crystal display, and the like displaying operation or selection screen and the like; an input/output unit 250 performing input/output of various data by an operator; a notification unit 260 including an alarm, for example, such as a buzzer, and the like; various controllers 270 respectively controlling each part of the substrate processing equipment 100; a program data memory unit 280 storing program data to perform processes of the substrate processing equipment 100; and a setting information memory unit 290 storing various setting information, such as recipe data, and the like, which is used when performing the processes based on the program data.

The program data memory unit 280 and the setting information memory unit 290 are formed by a recording medium, for example, such as a flash memory, a hard disk, a CD-ROM or the like. Data could also be advantageously read by the CPU 210.

A bus line, such as a control bus, a system bus, a data bus, and the like, are configured to electrically connect the CPU 210, ROM 220, RAM 230, display unit 240, input/output unit 250, notification unit 260, various controllers 270, program data memory unit 280, and setting information memory unit 290.

Various controllers 270 include a controller for controlling valves V1, V2 and V3, an APC valve 114, a TMP 115, a DP 116, RF power sources 118 and 152, a direct current power source 122, a switch 151, and the like.

The program data memory unit 280 stores, for example, not only a cleaning program 282 but also a wafer processing program, and the like. The setting information memory unit 290 stores, for example, cleaning setting information 292 which includes recipe data, such as an applied voltage, and the like, to control each part for the cleaning process, but also processing process setting information which includes recipe data, such as pressure inside the processing chamber, a flow rate of gas, RF power, and the like, to control each part for a processing process. The cleaning setting information 292 will be later described in detail. Further, the setting information memory unit 290 may store processing information which includes kinds of processes of each wafer. The processing information of each wafer is used, for example, to determine a kind of the process of each wafer when the cleaning is performed in the processing chamber.

(Specific Example of Processes Performed in Processing Chamber)

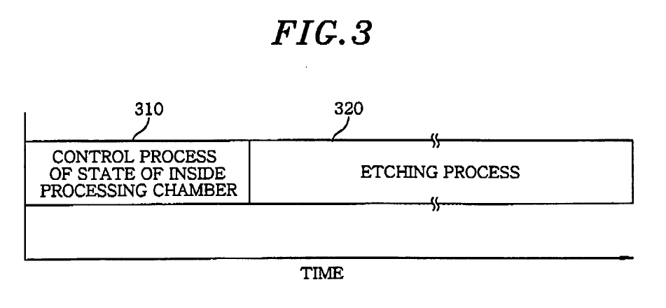

A specific example of a specific process which is performed in the processing chamber 110, in the plasma processing device 100 of the first embodiment of the present invention, will be described with reference to the drawing. That is, the plasma processing device 100 performs a specific process, by transferring a substrate into the processing chamber 110. The specific process may include different kinds of processes, depending on the steps of the process. For example, as illustrated in FIG. 3, the kinds of processes include a processing chamber condition controlling process (a processing chamber condition stabilizing process) 310, and an etching process 320 performed after the processing chamber condition controlling process 310.

For the processing chamber condition controlling process 310, for example, a control substrate (dummy substrate) is transferred into the processing chamber. The processing chamber condition controlling process 310 is performed under the nearly same conditions (for example, recipe, timing, and the like) as those of the etching process 320. The processing chamber condition controlling process 310 is performed to make the inside of the processing chamber 110 suitable for the etching process 320, which will be subsequently performed, by controlling an internal temperature of the processing chamber or reaction products which remain on the inner wall of the processing chamber. The processing chamber condition controlling process 310 is continuously performed whenever a plurality of control wafers (hereinafter, referred to as a ‘dummy wafer’) (for example, three dummy wafers) are transferred into the processing chamber 110.

In the processing chamber condition controlling process 310, for example, when a dummy wafer Wd is transferred into the processing chamber 110, the dummy wafer Wd is processed based on a control recipe. The control recipe is set to have the nearly same contents as, for example, an etching recipe used for the etching process 320. Further, the dummy wafer Wd is the same as a target wafer Wp (hereinafter, referred to as ‘target wafer’), which is finally fabricated as a product, by performing, for example, the etching process 320. For example, three dummy wafers Wd are sequentially and continuously processed to control the inside of the processing chamber 110 to be in an optimum condition for the etching process which will be subsequently performed, thereby stabilizing the internal condition of the processing chamber 110.

The etching process 320 is performed after the processing chamber condition controlling process 310 is performed using a plurality of dummy wafers. The etching process 320 is to etch the target wafer Wp inside the processing chamber 110, based on a specific etching recipe. The etching process 320 is continuously performed whenever a plurality of target wafers Wp (for example, one lot of twenty-five wafers) is transferred into the processing chamber 110.

In the etching process 320, for example, when the gate valve 132 is open, the target wafer Wp to be etched is transferred into the processing chamber 110 and is held on the susceptor 111. When the direct current voltage from the direct current power source 122 is applied to the electrode plate 120, the target wafer Wp is adsorbed on the susceptor 111.

Subsequently, the processing gas (for example, C₄F₈ gas, O₂ gas, and mixed gas including Ar gas) is introduced from the upper electrode 133 into the processing chamber 110, at specific quantity and flow rate. The internal pressure of the processing chamber 110 is controlled by the APC valve 114, and the like. Further, the RF power is applied to the susceptor 111 from the RF power source 118, at the same time when the RF power is applied to the upper electrode 133 from the RF power source 152. Then, the processing gas supplied from the upper electrode 133 becomes plasma. The radials or ions generated by the plasma are focused on the surface of the target wafer Wp by the focus ring 124, so that the surface of the target wafer Wp is physically or chemically etched.

When the etching process is ended, the wafer Wp being processed is transferred out from the processing chamber 110. In this manner, after the etching process 320 is continuously performed with respect to one lot, for example, twenty-five target wafers Wp, a series of processes are completed.

However, when the etching process 320 is continuously performed, particles, such as reactant products, are likely generated inside the processing chamber 110. Like the etching process 320, particles are likely generated inside the processing chamber 110, since the processing chamber condition controlling process 310 is also continuously performed. Due to these reasons, after the processes are performed in the processing chamber, the processing chamber needs a cleaning to remove particles.

However, when the cleaning for the processing chamber condition controlling process 310 is performed under the same conditions of, for example, the etching process 320, the cleaning may be likely excessive or deficient. For example, when the cleaning is deficient, particles are generated, and when the cleaning is excessive, the processing chamber condition (for example, an amount of the reaction products which remain in the inner wall of the processing chamber, or an internal temperature of the processing chamber) is not optimized. Consequently, the excessive or deficient cleaning may affect the processing process of a final wafer product or result in the quality inferiority of a semiconductor device fabricated on the wafer as the product.

Accordingly, in the present invention, the processing chamber cleaning is performed according to the kinds of processes. That is, since different optimum cleaning is performed based on the kinds of processes, excessive or deficient cleaning is prevented and the internal condition of the processing chamber is optimized.

(Processing Chamber Cleaning)

Cleaning of the processing chamber 110 in accordance with the embodiment of the present invention will be described. In the plasma processing device 100, like the processing chamber condition controlling process 310 or the etching process 320, the cleaning of the processing chamber 110 is controlled by the control unit 200. Specifically, the cleaning is realized by performing the cleaning program 282 stored in the program data memory unit 280 included in the control unit 200. The cleaning program 282 refers to the cleaning setting information 292 stored in the setting information memory unit 290.

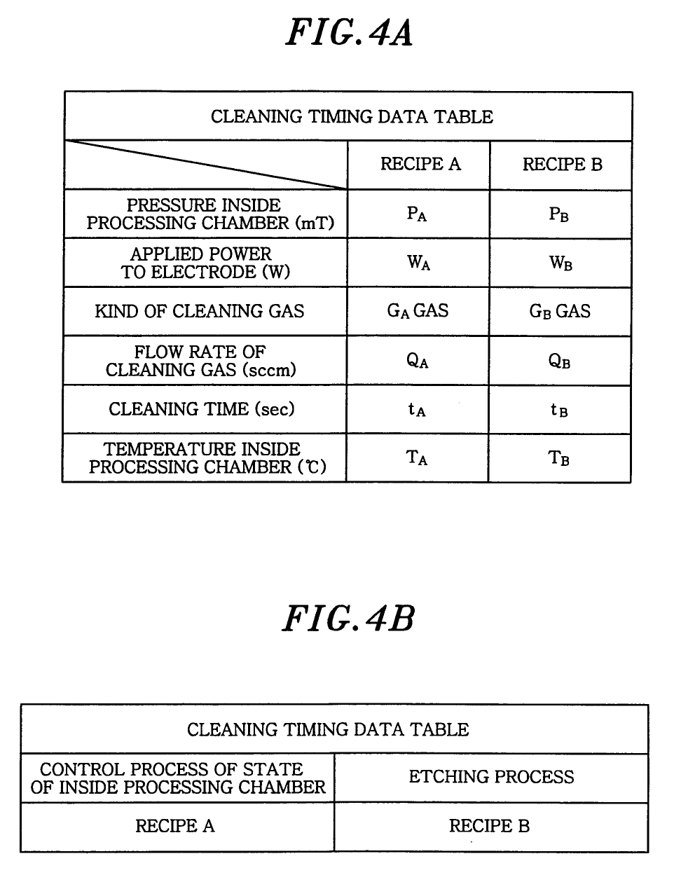

The contents of the cleaning setting information 292 will be described with reference to FIG. 4. The cleaning setting information 292 includes, for example, data in a cleaning recipe data table of FIG. 4A and in a cleaning recipe assignment data table of FIG. 4B.

The cleaning recipe data table of FIG. 4A is formed to set, at least, a cleaning recipe A and a cleaning recipe B. Setting items for the cleaning recipes include, for example, internal pressure of the processing chamber P_{A} and P_{B}, electrode applying power W_{A} and W_{B}, kind of cleaning gas G_{A} and G_{B}, quantity of cleaning gas Q_{A} and Q_{B}, cleaning time t_{A} and t_{B}, and internal temperature of the processing chamber T_{A} and T_{B}. The electrode applying power includes upper electrode applying power and lower electrode applying power. The internal temperature of the processing chamber includes an upper electrode temperature, a lower electrode temperature, and an inner wall temperature of the processing chamber. Examples of the cleaning recipes A and B will be described.

### [Cleaning Recipe A]

Internal pressure of processing chamber P_{A}: 100 mT
Upper electrode/lower electrode applying power W_{A}: 300 W/0 W
Kind of cleaning gas G_{A}: O₂ gas
Quantity of cleaning gas Q_{A}: 800 sccm
Cleaning time t_{A}: 40 seconds
Internal temperatures of upper electrode/lower
electrode/inner wall of processing chamber T_{A}: 60° C./60° C./20° C.

### [Cleaning Recipe B]

Internal pressure of processing chamber P_{B}: 100 mT
Upper electrode/lower electrode applying power W_{B}: 300 W/0 W
Kind of cleaning gas G_{B}:O₂ gas
Quantity of cleaning gas Q_{B}: 800 sccm
Cleaning time t_{B}: 20 seconds
Internal temperatures of upper electrode/lower
electrode/inner wall of processing chamber T_{B}: 60° C./60° C./20° C.

In the examples, the cleaning recipe A and the cleaning recipe B are different from each other in the cleaning time only. However, more different data may be inputted in the cleaning recipe data table. Further, many more recipes may be registered.

The cleaning recipe assignment data table of FIG. 4B is formed to set cleaning recipes by the kinds of the processes shown in FIG. 3. In the examples, the cleaning recipe A is set for the processing chamber condition controlling process 310 and the cleaning recipe B is set for the etching process 320.

Further, the cleaning recipe data table of FIG. 4A and the cleaning recipe assignment data table of FIG. 4B are related, based on the cleaning recipe as a key. When a few cleaning recipes being proposed are pre-registered in the cleaning recipe data table, it is easy to update the cleaning recipe assignment data table, that is, to change the assignment of cleaning recipes by the kinds of the processes.

The contents of the cleaning recipe data table and the cleaning recipe assignment data table are updated by an operation of an operator, using the input/output unit 250 (which is described with reference to FIG. 2). Further, the contents of the cleaning recipe data table and the cleaning recipe assignment data table may be updated from a host system (not shown) connected to the control unit 200 through network (not shown).

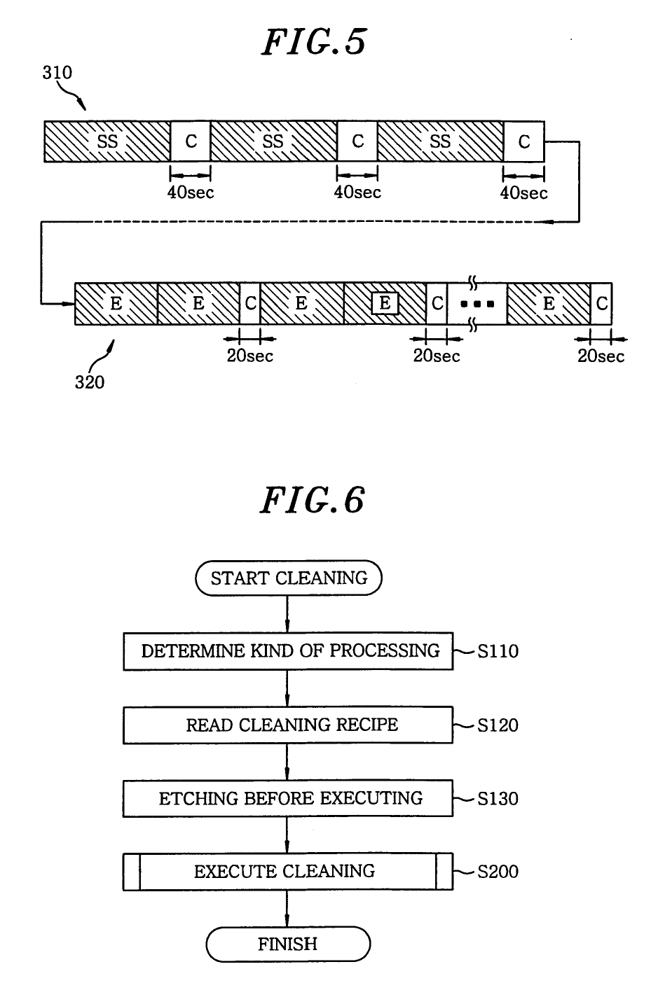

The cleaning of the processing chamber in the plasma processing device 100 according to the first embodiment will be described with reference to the drawing. FIG. 5 is a block diagram illustrating the process of the plasma processing device. The processing chamber condition controlling process 310 and the etching process 320 are described as examples of the processes performed inside the processing chamber. The processing chamber condition controlling process 310 is continuously performed on, for example, three dummy wafers Wd, by using the same etching recipe as that for the etching process. Subsequently, the etching process 320 is continuously performed on, for example, one lot, that is, twenty-five target wafers Wp.

Whenever a process for one wafer is ended in the processing chamber, the processing chamber cleaning is performed by a kind of the process. Specifically, as illustrated in FIG. 5, the control unit 200 performs the internal cleaning of the processing chamber 110 whenever the processing chamber condition controlling process 310 by one dummy wafer Wd is ended, for example, when the dummy wafer Wd is transferred out from the processing chamber. The control unit 200 performs the internal cleaning of the processing chamber 110 whenever the etching process 320 of one target wafer Wp is ended, for example, when the wafer Wp being processed is transferred out from the processing chamber.

Further, in FIG. 5, “SS” represents the processing chamber condition controlling process 310 per dummy wafer Wd, “E” represents the etching process 320 per target wafer Wp, and “C” represents the internal cleaning of the processing chamber 110. Further, FIG. 5 illustrates an example that a cleaning time for the processing chamber condition controlling process 310 is longer than that for the etching process 320.

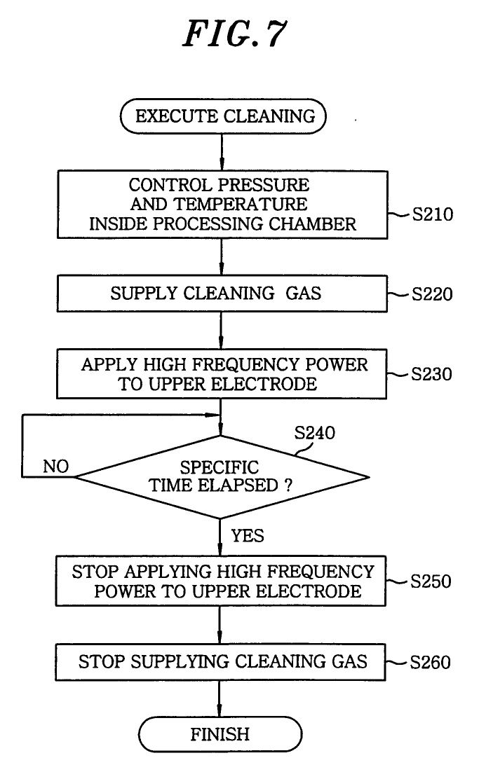

Examples of the internal cleaning of the processing chamber will be described with reference to drawing. FIG. 6 is a flow chart illustrating an example of the internal cleaning of the processing chamber in the embodiment. FIG. 7 is a flow chart illustrating an example of contents of the cleaning of FIG. 6.

As illustrated in FIG. 6, in step S110, the control unit 200 determines a kind of the process performed in the processing chamber 110. Specifically, for example, process information, which includes a kind of the process of each wafer, is pre-stored in the setting information memory unit 290, and the kind of the process is determined based on the process information. Further, a kind of the process may be determined based on, for example, process history information per wafer which is stored in the setting information memory unit 290.

In step S120, the control unit 200 reads a cleaning recipe assigned to the kind of the process, which is determined in step S110, from the cleaning recipe assignment data table (refer to FIG. 4). In the embodiment, when the kind of the process is determined as the processing chamber condition controlling process 310, the control unit 200 reads the cleaning recipe A, and when the kind of the process is determined as the etching process 320, the control unit 200 reads the cleaning recipe B.

The control unit 200 controls an operation of the plasma processing device 100, based on the cleaning recipe being read in step 120, and performs the internal cleaning of the processing chamber 110 after step S130.

Before performing the cleaning in the processing chamber 110, the control unit 200 performs a check prior to performance in step S130. The check prior to performance is to check whether the processing chamber 110 is normally ready for the cleaning or not.

For example, in case of the following states, the processing chamber 110 is not ready for a normal cleaning: when the processing process of the wafer W is being performed; when the wafer W exists in the processing chamber 110; when the wafer W is in the middle of being transferred out from the processing chamber 110; and when the processing chamber 110 is in process of maintenance. For example, the wafer W is determined as being in the processing process in the following states: when the processing gas is in the middle of being discharged into the processing chamber 1; when a back gas for controlling a temperature of the wafer W is in the middle of being introduced; when the electrode plate 120 (electrostatic chuck) for adsorbing the wafer W to be held is in the middle of being controlled; and when the RF power sources are in the middle of being controlled.

Further, when the gate valve 132 of the processing chamber 110 is open, the wafer W is determined as being in the middle of being transferred in/out. When a cover of the processing chamber 110 is open, the processing chamber 110 is determined as being in process of maintenance. The check prior to performance may be performed before determining a kind of the process.

When the control unit 200 determines that the processing chamber 110 is not ready for the cleaning, it finishes cleaning, for example, by assuming an error state (not shown) which is not suitable for performing such cleaning. When the control unit 200 determines that the processing chamber 110 is ready for the cleaning, it performs the internal cleaning of the processing chamber in step S200.

An example of the contents of the cleaning performed in step S200 will be described with reference to FIG. 7. In step S210, the control unit 200 controls the APC valve 114, the TMP 115 and the DP 116 so that the pressure inside the processing chamber 110 is 100 mT and the temperatures of the upper electrode 133 as the upper electrode, the susceptor 111 as the lower electrode, and the inner wall of the processing chamber 110 are respectively 60° C., 60° C. and 20° C. Further, the control unit 200 switches the switch 151 so that the susceptor 111 is set to be in an electrically floating state. Further, the control unit 200 breaks the conductivity of the electrode plate 120 and the direct current power source 122 so that the electrode plate 120 is set to be in an electrically floating state.

Subsequently, in step S220, the control unit 200 supplies O₂ gas as the cleaning gas, from the upper electrode 133 to the space S in the processing chamber 110. The quantity of the cleaning gas is controlled as 800 sccm (cm³/min, 1 atm, 0° C.), according to the cleaning recipe A or B.

In step S230, specific RF power, herein, 300 W RF power, is applied from the RF power source 152 to the upper electrode 133, according to the cleaning recipe A or B. Then, plasma is generated from the cleaning gas around the upper electrode 133, and ions or radicals are generated.

Then, since the susceptor 111 is set to be in the electrically floating state, no great self-bias is generated in the susceptor 111 and an inward-pulling force of the ions in the susceptor 111 is relieved. That is, since impact of the ions reaching the top of the susceptor 111 is in a low kinetic energy form, the top of the susceptor 111 is not cut by the ions.

Similarly, the radicals, which reach the top of the susceptor 111, contact with the reaction products accumulated on the top of the susceptor 111, thereby generating other volatile reaction products. The volatile reaction products easily leave (are volatized) from the top of the susceptor 111 and are discharged out of the processing chamber 110, through the substantive exhaustion line or roughing exhaustion line. Then, the top of the susceptor 111 or other parts thereof are cleaned so that the internal cleaning of the processing chamber 110 is progressed.

In step S240, whether a specific time passes or not is determined. The specific time is the cleaning time, for example, which is set in the cleaning recipes. When it is determined that the specific time passes in the step S240, the application of the RF power to the upper electrode 133 is stopped in the step S250, and the supply of the 02 gas as the cleaning gas to the processing chamber 110 is stopped in the step S260. Thus, the switch 151 is converted to electrically connect the susceptor 111 to the RF power source 118. Then, when the internal cleaning of the processing chamber is ended and the next process exists in the processing chamber, the next process is performed.

In the internal cleaning of the processing chamber in the embodiment, for example, after the processing chamber condition controlling process 310 is performed in the step S120, the cleaning recipe A is read based on the cleaning recipe data table of FIG. 4A and the cleaning recipe assignment data table of FIG. 4B in the step S120. Then, as illustrated in FIG. 5, whenever the processing chamber condition controlling process 310 by the dummy wafer Wd is finished as shown in FIG. 5, the cleaning is substantially performed for 40 seconds in each cleaning.

Further, in the etching process 320, in the step S120, the cleaning recipe B is read based on the cleaning recipe data table of FIG. 4A and the cleaning recipe assignment data table of FIG. 4B. Thereby, whenever the etching process of the wafer W is completed, the cleaning is substantially performed for 20 seconds in each cleaning.

As described above, in accordance with the first embodiment of the present invention, the cleaning setting information 292 is provided according to the different kinds of processes performed in the processing chamber 110 (the processing chamber condition controlling process 310 and the etching process 320). Thus, the cleaning is performed by different kinds of the processes while setting the cleaning setting information as optimum values. Thereby, the internal condition of the processing chamber 110 is optimized.

Further, in the processing chamber condition controlling process 310, the required condition of the processing chamber is different, depending on the contents of the processing process. Due to this reason, the cleaning time for the processing chamber condition controlling process 310 may be set depending on the required condition of the processing chamber for the processing process. For example, in the embodiment, the cleaning time (for example, 40 seconds) for the processing chamber condition controlling process 310 is set to be longer than that (for example, 20 seconds) for the etching process 320 (i.e., the processing process), thereby preventing the deficient cleaning in the processing chamber condition controlling process 310 which requires the longer time than the etching process 320. Therefore, the internal condition of the processing chamber 110 is optimized. Further, the cleaning time for the processing chamber condition controlling process 310 may be set to be shorter than that for the processing process, depending on the required condition of the processing chamber for the processing process.

In accordance with the embodiment of the present invention, the cleaning recipe A and the cleaning recipe B are different only in the cleaning time. However, the cleaning recipes may be changed in the other setting items, for example, the quantity of cleaning gas or the internal temperature of the processing chamber. For example, when the internal temperature of the processing chamber for the processing chamber condition controlling process 310 is set to be higher than that for the etching process 320 (i.e., the processing process), even though the cleaning time for the processing chamber condition controlling process 310 may not be set to be longer, the cleaning for the processing chamber condition controlling process 310 is controlled so as not to be deficient.

Further, in the embodiment, the cleaning recipe assignment data table of FIG. 4B is provided. Thus, when the number of cleaning recipes greater than the number of processes is prepared, a desired cleaning recipe is selected to be assigned for a kind of a desired process, thereby more simply performing the cleaning recipe setting. Since the setting items are not limited to those of the cleaning recipes A and B, they may be increased or decreased.

### Second Embodiment

A plasma processing device according to a second embodiment of the present invention will be described. Since the block diagram of the constitution of the plasma processing device according to the second embodiment is the same as that for the first embodiment of FIG. 1, the description thereof will be omitted. In the first embodiment, it is described that the cleaning recipes are changed by different kinds of processes performed in the processing chamber 110. However, in the second embodiment, it will be described that the cleaning timing is changeable by different kinds of the processes performed in the processing chamber 110.

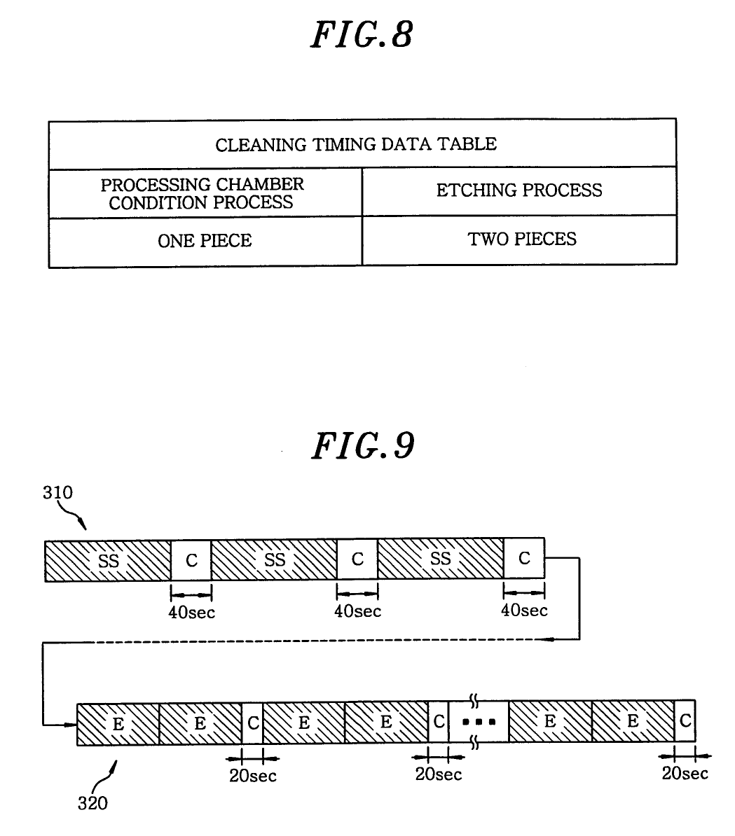

Specifically, the setting information memory unit 290 of the control unit 200 in the second embodiment stores not only the cleaning recipe data table and cleaning recipe assignment data table of FIG. 4, but also a cleaning timing data table A of FIG. 8 as the cleaning setting information 292. The cleaning timing data table is the setting information on the timing to perform the cleaning according to the kinds of processes.

Here, it will be described that the cleaning time is set, depending on the number of wafers. Specifically, the cleaning time for the processing chamber condition controlling process 310 is set based on the number of dummy wafers Wd. Further, the cleaning time for the etching process 320 is set based on the number of target wafers Wp. For example, in accordance with an example of the cleaning timing data table of FIG. 8, the cleaning for the processing chamber condition controlling process 310 is performed whenever one dummy wafer Wd is processed, and the cleaning for the etching process 320 is performed whenever two target wafers Wp are processed.

(Example of Cleaning)

Internal cleaning of the processing chamber in the second embodiment will be described with reference to the drawing. FIG. 9 is a block diagram illustrating processes performed by the plasma processing device according to the second embodiment. As the processes performed in the processing chamber, for example, the processing chamber condition controlling process 310 and the etching process will be described. The processing chamber condition controlling process 310 is continuously performed with respect to, for example, three dummy wafers Wd, based on the same etching recipe as that for the etching process 320. Subsequently, the etching process 320 is continuously performed with respect to, for example one lot, that is, twenty-five target wafers Wp.

Whenever the process of one wafer, performed in the processing chamber, is ended, the internal cleaning of the processing chamber is performed by kinds of the processes. In the embodiment, the cleaning timing is set. Thus, after the process performed in the processing chamber is ended, the cleaning may not be performed, depending on the cleaning timing being set.

Further, in FIG. 9, like FIG. 5, “SS” represents the processing chamber condition controlling process 310 per dummy wafer Wd, “En represents the etching process 320 per target wafer Wp, and “C” represents the internal cleaning of the processing chamber 110.

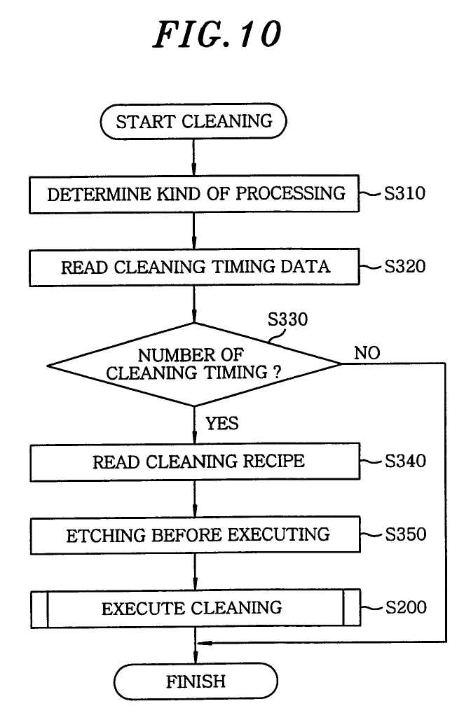

An example of the internal cleaning of the processing chamber will be described with reference to the drawing. FIG. 10 is a flow chart illustrating an example of the internal cleaning of the processing chamber in the embodiment. As illustrated in FIG. 10, in step S310, the control unit 200 determines a kind of a process which is performed in the processing chamber 110. Specifically, for example, the control unit 200 determines the kind of the process, based on the process information including a kind of the process for each wafer pre-stored in the setting information memory unit 290.

In step S320, the control unit 200 reads timing data which are assigned to the kind of the process being determined in step S310, based on the cleaning timing data table of FIG. 8. In the second embodiment, when the kind of the process is determined as the processing chamber condition controlling process 310, the control unit 200 reads the timing data (one), and when the kind of the process is determined as the etching process 320, the control unit 200 reads the timing data (two).

Subsequently, whether the number of the cleaning data being read is same as the number of the cleaning timing or not is determined in step S330. Specifically, for example, whether each process is ended, the number of wafers is counted and the counted value is temporarily stored in, for example, RAM 230. Then, the number of the timing data being read in the step S320 is compared with the number of the counted value being stored in the RAM 230. When it is determined that the number of the counted value does not reach the number of the cleaning timing, the step is finished without performing the cleaning of the processing chamber.

When it is determined that the counted value reaches the number of the cleaning timing in step S330, the counted value is 0 and the cleaning of the processing chamber is performed from step S340. That is, in the step S340, for example, the cleaning recipe assigned to the kind of the process as determined in the step S310 is read from the cleaning recipe assignment data table of FIG. 4, and in step S350, the check prior to performance is performed. Since the process same as the step S130 of FIG. 6 is performed in the step S350, no description thereof will be presented. Further, the check prior to performance may be performed before determining the kind of the process.

When it is determined, by the check prior to performance, that the condition of the processing chamber 110 is not appropriate for the cleaning, the cleaning is finished for example, by assuming an error state (not shown) which is not suitable for performing such cleaning. However, when it is determined that the processing chamber 110 is in the condition that the cleaning is normally performed, the cleaning of the processing chamber is performed, based on the cleaning recipe in step S200. When the processing chamber cleaning is ended and the next process needs to be performed in the processing chamber, the next process is performed.

In the internal cleaning of the processing chamber in the present embodiment, for example, when the processing chamber condition controlling process 310 is performed, the “one” timing data is read based on the cleaning timing data table of FIG. 8 in the step S320 and simultaneously the cleaning recipe A is read based on the cleaning recipe data table of FIG. 4A and the cleaning recipe assignment data table of FIG. 4B in the step S340. Thereby, whenever the processing chamber condition controlling process 310 by the dummy wafer Wd is performed as described in FIG. 9, the cleaning is substantially performed for 40 seconds each time.

Further, in the etching process 320, the “two” timing data is read based on the cleaning timing data table of FIG. 8 in the step S320, and the cleaning recipe B is read based on the cleaning recipe data table of FIG. 4A and the cleaning recipe assignment data table of FIG. 4B in the step S340. Thereby, whenever the etching process 320 of two target wafers Wp is continuously performed as described in FIG. 9, the cleaning is substantially performed for 20 seconds each time.

As described above, in accordance with the second embodiment, the cleaning setting information 292 (cleaning recipes and cleaning timing) is provided according to the kinds of processes performed in the processing chamber 110 (the processing chamber condition controlling process 310 and the etching process 320). Thus, the cleaning is performed by the kinds of the processes while setting the cleaning setting information 292 as their optimum vales. Thereby, the internal condition of the processing chamber 110 (chamber condition) is optimized, and the throughput is improved.

Further, in the second embodiment, the cleaning timing is set, for example, based on the number of dummy wafers Wd and the number of target wafers Wp. But the cleaning timing is not limited thereto. The cleaning timing may be set based on elapsed time. Further, the specific number of the cleaning may be performed for each process, at nearly equal timing intervals, by setting the number of the cleaning according to the kinds of processes. Further, when it is considered that particles are increased in the processing chamber 110 as the number of the processing processes is continuously increased, the cleaning may be performed at a long interval at the beginning and it may be performed at progressively shorter intervals.

Further, the cleaning timing data may be data which are added to the process information of each wafer (including a kind of the process) before the process is performed in the processing chamber 110. This additional data is added to the process information of the wafer, based on, for example, the cleaning timing data table of FIG. 8.

For example, in the substrate processing equipment which performs a wafer process by taking out one wafer from a wafer cassette receiving a plurality of wafers and by transferring the wafer to the processing chamber 110 so that the wafer is processed, the additional data may be added to the process information of a wafer whenever each wafer is taken out from the wafer cassette.

Specifically, the number of wafers is counted whenever a wafer is taken out from the wafer cassette, and the counted value is temporarily stored in, for example, the RAM 230 by kinds of processes. When it is determined that the counted value of the number of wafers does not reach the number of wafers, for example, for the cleaning timing of FIG. 8, the additional data defining that no cleaning of the processing chamber is performed (no cleaning data exists) is added. Further, when it is determined that the counted value of the number of wafers reaches the number of wafers for the cleaning timing, the counted value is 0 and the additional data defining that the cleaning of the processing chamber is performed (cleaning data exists) is added.

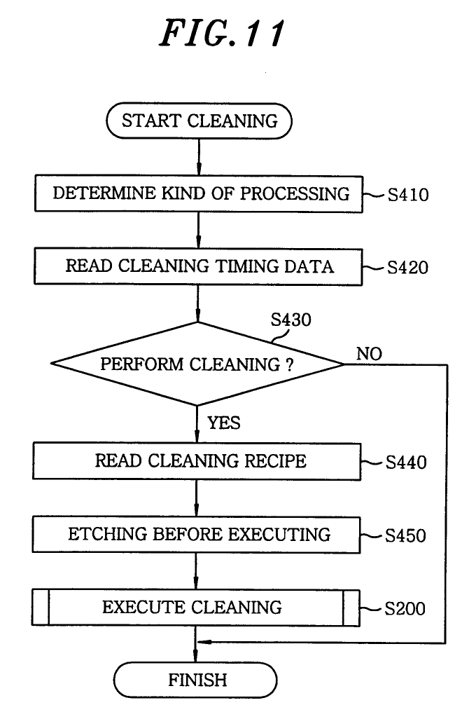

FIG. 11 illustrates an example of the internal cleaning of the processing chamber when the cleaning timing is determined, based on the additional data which is added to the process information of a wafer. As illustrated in FIG. 11, a kind of a process is determined in step S410; a cleaning timing data is read in step S420; and whether or not perform the cleaning is determined in step S430. The kind of the process is determined based on the wafer process information (including kinds of processes), the additional data which is added to the wafer process information is read as the cleaning timing data, and whether or not to perform the processing chamber cleaning is determined based on the additional data.

When no cleaning data exists, that is, when the additional data does not perform the cleaning of the processing chamber in the step S430, the step is finished without performing the cleaning of the processing chamber. When the cleaning data exists, that is, when the cleaning of the processing chamber is performed in the step S430, the cleaning of the processing chamber is performed after the step S440.

That is, in the step S440, for example, the cleaning recipe, assigned to the kind of the process which is determined in the step S410, is read from the cleaning recipe assignment data table of FIG. 4, and the check prior to performance is performed in step S450. Since the same process in the step S130 of FIG. 6 is performed in the step S450, no description thereof will be presented. Further, the check prior to performance may be performed before the kind of the process is determined.

When it is determined, by the check prior to performance, that the condition of the processing chamber 110 is not suitable for the cleaning, the cleaning is ended, for example, by assuming an error state (not shown) which is not suitable for performing such cleaning. However, when it is determined that the processing chamber 110 is normally in the condition for the cleaning, the cleaning of the processing chamber is performed, based on the cleaning recipe in the step S200. When the cleaning of the processing chamber is ended and the next process needs to be performed in the processing chamber, the next process is performed.

In accordance with the cleaning of the processing chamber of FIG. 11, whether or not to perform the cleaning is simply determined based on the additional data of the wafer process information. Further, since it is not necessary to determine whether or not to reach the cleaning timing for each time the cleaning of the processing chamber is performed, the throughput is improved.

The substrate processing equipment to which the present invention is applied may include a plurality of processing chambers or may continuously process a wafer taken out from the wafer cassette by sequentially transferring the wafer to each processing chamber. When the present invention is applied to this substrate processing equipment, the cleaning may be performed per processing chamber 110, according to the flow charts of FIGS. 6, 10 and 11. Thereby, each processing chamber 110 may be cleaned at a desired timing according to the kind of a process.

Further, when each processing chamber 110 is cleaned according to the flow chart of FIG. 11, the additional data per processing chamber may be added to the wafer process information, based on the cleaning timing which is set as the number of wafers in each processing chamber, before the process is performed in each processing chamber, for example when a wafer is taken out from the wafer cassette. Thereby, whether or not to perform the internal cleaning of each processing chamber 110 is simply determined.

In the first and second embodiment, the processing chamber condition controlling process and the etching process are described as examples of the kinds of the processes which are performed in the processing chamber. The processing chamber condition controlling process is performed by transferring the control wafer Wd into the processing chamber, and the etching process is performed by transferring the target wafer Wp into the processing chamber. However, for example, after the etching process is ended with respect to one lot of target wafers Wp (for example, twenty-five target wafers Wp) and when another cleaning process is performed by transferring the cleaning wafer Wc into the processing chamber, this cleaning process may be classified as being one kind of a process.

The aforementioned cleaning process may be performed before the etching process is performed with respect to one lot (for example, twenty five) of target wafers Wp or during the etching process. When the internal cleaning of the processing chamber of the present invention is performed after the aforementioned cleaning process, the recipe and timing thereof may be set, by adding data to the cleaning recipes of FIGS. 4(a) and 4(b) and the cleaning timing of FIG. 8, independently from the kinds of the other processes. Alternately, the internal cleaning of the processing chamber of the present invention may be substituted for the aforementioned cleaning process.

In the first and second embodiment, it is described that the internal cleaning of the processing chamber (called ‘waferless cleaning’) is performed after the process performed in the processing chamber is ended and wafers are transferred out and when there are no wafers in the processing chamber 110. However, the present invention is not limited to the waferless cleaning. The internal cleaning of the processing chamber of the present invention may be performed after the process performed in the processing chamber 110 is ended and the wafers are transferred out and when there is another cleaning wafer being transferred into the processing chamber 110.

Further, in the first and second embodiments, it is described that the internal cleaning of the processing chamber is performed by generating plasma in the processing chamber. However, the internal cleaning of the processing chamber according to the embodiments is not limited thereto. The cleaning of the processing chamber may be performed without generating plasma in the processing chamber (called a ‘plasmaless’ cleaning).

Further, in the cleaning performed by generating plasma, since an action of removing a static electricity of the electrode plate 120 using plasma is included, there is no need to additionally perform a process of removing the static electricity of the electrode plate 120. However, in the plasmaless cleaning, since no plasma is generated, it is necessary to additionally perform the process of removing the static electricity of the electrode plate 120.

The cleaning according to the first and second embodiment of the present invention may be applied to a system including a plurality of devices or an apparatus including a single device. The present invention is realized by supplying media, such as a memory medium of storing a software program to realize the above-described functions according to the embodiments, and the like, to the system or apparatus and reading the program stored in the media, such as the memory medium, and the like, by a computer (or CPU or MPU) of the system or apparatus.

In this case, the program readable from the media, such as the memory medium and the like, realizes the above-described functions of the embodiments, and the media, such as the memory medium of storing the program, and the like, constitutes the present invention. Examples of the media, such as the memory medium and the like, for supplying the program include, for example, a floppy (registered trademark) disk, a hard disk, an optical disk, a magneto-optical disk, CD-ROM, CD-R, CD-RW, DVD-ROM, DVD-RAM, DVD-RW, DVD+RW, a magnetic tape, a nonvolatile memory card, ROM, and the like. Further, the program of the media may be provided by a downloading via network.

Further, the above-described functions according to the embodiments may be realized not only by performing the program which are read by the computer or but also by performing a part of an actual process or the entire actual process by the OS, and the like which operate in the computer, based on the instruction of the program. This is within the scope of the present invention.

Further, after the program, which is read from the media, such as the memory medium and the like, is entered in memory included in a capability expansion board inserted in the computer or a capability expansion unit connected to the computer, the above-described functions according to the embodiments may be realized by performing a part of an actual process or the entire actual process by the CPU, and the like which are provided to the capability expansion board or capability expansion unit, based on the instructions of the program. This is within the scope of the present invention.

While the invention has been shown and described with respect to the embodiments, it will be understood by those skilled in the art that various changes and modifications may be made without departing from the spirit and scope of the invention as defined in the following claims.

For example, in the first and second embodiment, it is described that the present invention is applied to the plasma processing device which performs the etching process of the wafer. However, the present invention is not limited thereto. The present invention may be applied to a device for forming a layer on the wafer, for example, a plasma CVD device, a sputtering device, a thermal oxidation device, and the like. Further, the present invention may be applied to substrate processing equipment with respect to other substrates, for example, flat panel display (FPD), mask reticle for photo mask, and the like, in addition to a wafer, and it may be applied to micro electro mechanical system (MEMS) manufacturing equipment.

The present invention is applicable to a cleaning method of substrate processing equipment, substrate processing equipment, and a recording medium for recording a program.

While the invention has been shown and described with respect to the preferred embodiments, it will be understood by those skilled in the art that various changes and modification may be made without departing from the scope of the invention as defined in the following claims.

What is claimed is:

1. A cleaning method of substrate processing equipment, comprising:
performing a processing chamber cleaning after a specific process is performed on a substrate transferred into the processing chamber,
wherein the cleaning is performed by a kind of the process, based on specific cleaning setting information which is set in advance according to kinds of processes performed in the processing chamber.

2. A cleaning method of substrate processing equipment, comprising:
performing a processing chamber cleaning after a specific process is performed on a substrate transferred into the processing chamber,
wherein the cleaning is performed by a recipe for a kind of the process, based on cleaning recipes which are prepared by kinds of processes performed in the processing chamber and are pre-stored in a setting information memory unit.

3. The cleaning method of claim 2, wherein the kinds of processes performed in the processing chamber include at least:
a processing process which is performed by transferring a target substrate into the processing chamber; and
a processing chamber condition controlling process which is performed by transferring a control substrate into the processing chamber, in order to control a condition of the processing chamber so as to maintain the condition suitable for the processing process, before the processing process is performed.

4. The cleaning method of claim 3, wherein each cleaning recipe includes at least a time for performing the cleaning and an internal temperature of the processing chamber, and when the kind of the process is the processing chamber condition controlling process, the time for performing the cleaning and/or the internal temperature of the processing chamber are set, depending on a required condition of the processing chamber for the processing process.

5. The cleaning method of claim 4, wherein, the time for performing the cleaning, when the kind of the process is the processing chamber condition controlling process, is set to be longer than that when the kind of the process is the processing process.

6. The cleaning method of claim 4, wherein the internal temperature of the processing chamber, when the kind of the process is the processing chamber condition controlling process, is set to be higher than that when the kind of the process is the processing process.

7. A cleaning method of substrate processing equipment, comprising:
performing a processing chamber cleaning after a specific process is performed on a substrate transferred into the processing chamber,
wherein the cleaning is performed by timing for a kind of the process, based on cleaning timing which is provided by kinds of processes performed in the processing chamber and is pre-stored in a setting information memory unit.

8. The cleaning method of claim 7, wherein the kinds of processes performed in the processing chamber include at least:
a processing process which is performed by transferring a target substrate into the processing chamber; and
a processing chamber condition controlling process which is performed by transferring a control substrate into the processing chamber, in order to control a condition of the processing chamber so as to maintain the condition suitable for the processing process, before the processing process is performed,
wherein the setting information memory unit individually stores at least cleaning timing by the kinds of the processes.

9. The cleaning method of claim 8, wherein each of the cleaning timing is set based on the number of substrates, and, for the processing chamber condition controlling process, the cleaning is performed only when the processing chamber condition controlling process of the set number of the control substrates is ended; and for the processing process, the cleaning is performed only when the processing process of the set number of the substrates to be processed is ended.

10. A cleaning method of substrate processing equipment, comprising:
performing a processing chamber cleaning after a specific process is performed on a substrate transferred into the processing chamber,
wherein the cleaning is performed by a recipe and timing for a kind of the specific process, based on cleaning recipes and cleaning timing which are provided by kinds of processes performed in the processing chamber and are pre-stored in a setting information memory unit.

11. A cleaning method of substrate processing equipment, which performs a processing chamber cleaning after a specific process is performed on a substrate transferred into the processing chamber, comprising:
including a setting information memory unit which stores cleaning setting information by kinds of processes performed in the processing chamber;
determining a kind of the process performed in the processing chamber;
obtaining the cleaning setting information for the kind of the process being determined, from the setting information memory unit; and
performing the cleaning for the kind of the process, based on the cleaning setting information being obtained.

12. The cleaning method of claim 2, wherein the cleaning generates plasma in the processing chamber.

13. A substrate processing equipment which performs a processing chamber cleaning after a specific process is performed on a substrate transferred into the processing chamber, comprising:
a setting information memory unit which stores cleaning setting information by kinds of processes performed in the processing chamber; and
a control unit which, upon cleaning, performs the cleaning for the kind of the process, based on the cleaning setting information being obtained from the setting information memory unit.

14. A substrate processing equipment which performs a processing chamber cleaning after a specific process is performed on a substrate transferred into the processing chamber, comprising:
a setting information memory unit which stores cleaning setting information, which is set depending on kinds of processes performed in the processing chamber; and
a control unit which, upon cleaning, determines the kind of the process performed in the processing chamber, obtains the cleaning setting information for the kind of the process being determined from the setting information memory unit, and performs the cleaning for the kind of the process, based on the cleaning setting information being obtained.

15. A computer readable recording medium for recording a program to perform a cleaning method of substrate processing equipment which performs a processing chamber cleaning after a specific process is performed on a substrate transferred into the processing chamber,
wherein the substrate processing equipment includes a setting information memory unit for storing cleaning setting information by kinds of processes performed in the processing chamber, and
a computer stores a program for performing steps of determining a kind of the process performed in the processing chamber; obtaining the cleaning setting information for the kind of the process being determined from the setting information memory unit; and performing the cleaning for the kind of the process, based on the cleaning setting information being obtained.
